(19) United States
(12) Patent Application Publication
(10) Pub. No.: US 2010/0071717 A1
(43) Pub. Date: Mar. 25, 2010

(54) METHOD AND APPARATUS FOR CLEANING VEHICLES

(75) Inventor: John G. Lenhart, Green Bay, WI (US)

Correspondence Address: MICHAEL BEST & FRIEDRICH LLP, 100 E WISCONSIN AVENUE, Suite 3300, MILWAUKEE, WI, 53202, US

(73) Assignee: R. LEWIS TECHNOLOGIES, INC., Green Bay, WI (US)

(21) Appl. No.: 11/953,461

(22) Filed: Dec. 10, 2007

Related U.S. Application Data
(63) Continuation of application No. PCT/US2005/044377, filed on Dec. 9, 2005.
Application No. PCT/US2005/044377 is a continuation-in-part of application No. PCT/US2005/020673, filed on Jun. 10, 2005.
Application No. PCT/US2005/020673 is a continuation-in-part of application No. 11/570,322, filed on Jun. 27, 2007, now abandoned.
(60) Provisional application No. 60/578,783, filed on Jun. 10, 2004.
(60) Provisional application No. 60/578,783, filed on Jun. 10, 2004.

(51) Int. Cl. B08B 7/00

(52) U.S. Cl. 134/1

(57) ABSTRACT

A method and apparatus for cleaning vehicles. The method of cleaning a vehicle can include irradiating an exterior surface of the vehicle with artificial electromagnetic radiation. The exterior surface of the vehicle can have soil deposited thereon, which can include a plurality of PAHs. At least some of the plurality of PAHs can be bonded together via a chemical bond having a bond energy. The method can further include breaking the chemical bond with the artificial electromagnetic radiation. The artificial electromagnetic radiation can have a predetermined wavelength that corresponds to the energy required to break the chemical bond. The method can further include cleaning the vehicle.

### CROSS-REFERENCE TO RELATED APPLICATIONS

Priority is hereby claimed to International Patent Application No. PCT/US05/20673, filed Jun. 10, 2005, the entire contents of which are incorporated herein by reference, and claims priority to U.S. Provisional Patent Application No. 60/578,783, filed Jun. 10, 2004, the entire contents of which are incorporated herein by reference. This is a continuation-in-part of International Patent Application No. PCT/US05/20673, filed Jun. 10, 2005.

### BACKGROUND

A variety of vehicle cleaning apparatuses and methods can be used to remove a variety of soil types from the exterior of vehicles. An oily road film can be difficult to completely remove from a vehicle without the use of harsh or hazardous chemicals, such as hydrofluoric acid, which can be dangerous to humans, equipment and the vehicle. The soil removed from the vehicle in such situations can be treated as a hazardous waste in some areas of the country because of its chemical composition and potential health risks to humans and the environment.

### SUMMARY

The present invention is generally directed to a vehicle cleaning apparatus and method. The vehicle cleaning apparatus can include an electromagnetic wave application apparatus for applying specific wavelengths, or specific range of wavelengths, of electromagnetic radiation to the vehicle. In some embodiments, the electromagnetic radiation can be used to break bonds (e.g., cross-links, other covalent bonds, etc.) or interactions (e.g., van der Waals interactions, hydrogen bonding, other non-covalent bonds, etc.) that may have occurred between soil molecules and/or between soil and an exterior surface of a vehicle. In some embodiments, the electromagnetic radiation can be used to form specific (discrete) bonds or interactions between soil molecules or between soil and an exterior surface of a vehicle in a directed manner in order to break down the soil using one or more subsequent electromagnetic radiation applications. In some embodiments, the electromagnetic radiation can be used to break down the soil into benign constituents, or to break down the soil into compounds that can render hazardous chemicals benign. The method for cleaning a vehicle can include irradiating the vehicle with electromagnetic radiation prior to, during, or subsequent to a variety of other cleansing procedures.

Some embodiments of the present invention provide a method of cleaning a vehicle. The method can include irradiating an exterior surface of the vehicle with artificial electromagnetic radiation. The exterior surface of the vehicle can have soil deposited thereon, which can include a plurality of PAHs, at least some of the plurality of PAHs being bonded together via a chemical bond having a bond energy. The chemical bond can be formed between at least two of O, S, N, and a metal ion. The method can further include breaking the chemical bond with the artificial electromagnetic radiation. The artificial electromagnetic radiation can have a predetermined wavelength that corresponds to the energy required to break the chemical bond. The method can further include cleaning the vehicle.

In some embodiments of the present invention, a method of cleaning a vehicle is provided. The method can include emitting artificial electromagnetic radiation toward an exterior surface of the vehicle. The exterior surface of the vehicle can have soil deposited thereon. The soil can include a plurality of PAHs, at least some of the plurality of PAHs being bonded together via a chemical bond having a bond energy. The artificial electromagnetic radiation can have a predetermined wavelength that corresponds to the bond energy of the chemical bond. The method can further include breaking the chemical bond with the artificial electromagnetic radiation without substantially pyrolyzing the soil.

Some embodiments of the present invention provide a method of cleaning a vehicle. The method can include irradiating an exterior surface of a vehicle with artificial electromagnetic radiation. The exterior surface of the vehicle can have soil deposited thereon, at least a portion of the soil being bonded together via a chemical bond. The method can further include breaking the chemical bond with the artificial electromagnetic radiation having a wavelength in the UV spectrum, and applying detergent to the exterior surface of the vehicle in a touch-free manner after irradiating the exterior surface of the vehicle. The method can further include rinsing the detergent from the exterior surface of the vehicle in a touch-free manner.

Other features and aspects of the invention will become apparent by consideration of the detailed description and accompanying drawings.

### BRIEF DESCRIPTION OF THE DRAWINGS

FIG. 1 illustrates a front elevational view of an electromagnetic wave application apparatus according to one embodiment of the present invention.

FIG. 2 illustrates a partial side view of the electromagnetic wave application apparatus of FIG. 1.

FIG. 3 illustrates a top isometric view of a vehicle cleaning apparatus and an electromagnetic wave application apparatus according to another embodiment of the present invention.

FIG. 4 illustrates a top view of an electromagnetic wave application apparatus (with portions not shown) according to another embodiment of the present invention.

FIG. 5 illustrates a front elevational view of the electromagnetic wave application apparatus of FIG. 4 (with portions not shown).

FIG. 6 illustrates a front isometric view of an electromagnetic wave application apparatus according to another embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The present invention is directed to a vehicle cleaning apparatus and method. The vehicle cleaning apparatus can include an electromagnetic wave application apparatus for applying artificial, or non-natural, electromagnetic radiation to the vehicle. The electromagnetic wave application apparatus can emit electromagnetic waves at various wavelengths and intensities to break specific soil bonds or cross-links that may have formed or to eliminate specific interactions between the soil and an exterior surface of a vehicle. This invention is further directed to a method for irradiating a vehicle with specific electromagnetic waves.

As used herein and in the appended claims, the term “exterior surface” refers to a portion of an exterior surface that is defined by a vehicle, and need not include the entire exterior surface of a vehicle.

As used herein and in the appended claims, the term “vehicle” refers to any device or apparatus capable of movement, on or in which a person or object can travel or be transported, including, but not limited to, one or more of automobiles, trucks, buses, trailers, trains, boats, planes, motorcycles, sidecars, strollers, bicycles, wagons, shopping carts, or combinations thereof, and any other device or apparatus capable of movement for the purpose of transporting an object or person.

As used herein and in the appended claims, the term “soil” refers to any substance on the exterior of a vehicle that affects at least one of physical, chemical and aesthetic properties of the vehicle including, without limitation, at least one of dirt, mud, rain, acid rain, snow, salt, ice, oil, gasoline, sewage, tire debris, paint, animal waste, vegetation or debris thereof, road film, atmospheric fallout, pollution, factory exhaust, incineration exhaust, vehicle exhaust, tree sap, road tar, asphalt, and combinations thereof.

As used herein and in the appended claims, the term “electromagnetic wave(s)” refers to one or more waves including, without limitation, at least one of long waves, radio waves, infrared radiation (“IR”), visible light, ultraviolet radiation (“UV”; including UV-A and UV-B radiation), X rays, gamma rays, and combinations thereof.

As used herein and in the appended claims, the term “electromagnetic radiation” refers to a series of electromagnetic waves, and can include a variety of electromagnetic waves separated in time and/or space.

Vehicle cleansing procedures can include, without limitation, at least one of applying a pre-soaking solution (e.g., water, solvents, surfactants, enzymes, bleach, chelators, acids, alkalines, salts, etc.) over the exterior of the vehicle, applying a detergent over the exterior of the vehicle, rinsing the detergent off of the exterior of the vehicle, applying a spot-resistant rinse to the exterior of the vehicle, applying a variety of finishing products or protective coatings (e.g., carnauba wax, mineral seal oil, quaternary amines, polymers, dyed foam, scents, UV protectants, rust inhibitors, optical brighteners, etc) to the exterior of the vehicle, and a combination thereof. Electromagnetic waves or radiation can be applied to the exterior of the vehicle prior to, during, or subsequent to any of the above-listed cleansing procedures, and can be applied to any portion of a vehicle.

Touch-free or touchless vehicle cleansing procedures can include any Of the above vehicle cleansing procedures, and are performed without physically contacting the exterior surface of the vehicle with a cleaning element. The term “cleaning element,” as used herein and in the appended claims, is meant to include an element that cleans a surface by applying physical contact to the surface, and can include a brush, a pad, a sponge, a wiper, a towel, a rag, a scrubber, or any other apparatus capable of cleaning a surface by contacting the surface. An example of a touch-free vehicle cleansing procedures is applying detergent to an exterior surface of a vehicle, for example by spraying the detergent, without rubbing the surface, either before, during or after application of the detergent.

Soil on an exterior surface of a vehicle may become cross-linked (or otherwise bonded or interacted) under a variety of weather conditions including, without limitation, extended sun exposure, extended sun exposure subsequent to rain exposure, humidity, heat from the vehicle, atmospheric fallout, exhaust, pollution, and a combination thereof.

One example of a soil that is often found on the exterior surface of vehicles is an oily film. The oily film is generally a liquid soil that can include a “soup” of polycyclic aromatic hydrocarbons (PAH), heavy metal ions, or both. The oily film can act as a “glue” for other soils found on the vehicle, and can be difficult to remove from a vehicle without the use of harsh or hazardous chemicals, and/or friction. The term “friction” is used to refer to physical, and sometimes aggressive, contact between an exterior surface of a vehicle and a cleaning element, and/or can also include the use of abrasives on the exterior surface of the vehicle.

PAHs can be produced by high-temperature reactions such as incomplete combustion and pyrolysis of fossil fuels and other organic matter. PAHs can include, without limitation, at least one of acenaphthene, acenaphthylene, acephenanthrylene, anthanthrene, anthracene, benzo[a]coronene, benzo[a]naphthacene, benzo[a]pyrene, benzo[b]chrysene, benzo[b]fluorene, benzo[c]chrysene, benzo[c]phenanthrene, benzo[e]pyrene, benzo[ghi]fluoranthene, benzo[ghi]naphtha[cde]perylene, benzo[ghi]perylene, benzo[j]fluoranthene, benzo[rst]dinaphtho[defg,ijkl]pentaphene, benzo[rst]phenanthro[1,10,9-cde], benz[a]anthracene, benz[e]acephaninthrylene; benz[rst]anthra[cde]pentaphene, chrysene, coronene, cyclopenteno[cd]pyrene, dibenzo[b,def]chrysene, dibenzo[bc,ef]coronene, dibenzo[cd,lm]perylene, dibenzo[g,p]chrysene, dibenzo[j,lm]naphtha[ab]perylene, dibenz[a,c]anthracene, dibenz[a,h]anthracene, dibenz[a,j]anthracene, dinaphtho[defg,opqr]pentacene, fluoranthene, fluorene, hexabenzo[a,cd,f,j,lm,o]perylene, naphthacene, naphthalene, naphtho[a]anthracene, naphtho[bcd]perylene, naphtho[d]coronene, pentabenzo[a,cd,f,j,lm]perylene, pentacene, pentaphene, perylene, phenanthrene, phenanthro[3,4-c]phenantrene, picene, pyranthrene, pyrene, tetrabenzo[a,cd,f,lm]perylene, triphenylene, asphaltenes and/or maltenes (i.e., as found in asphalt) and combinations thereof.

PAHs can react with a variety of other elements in the environment, including without limitation, at least one of oxygen, sulfur, nitrogen, and combinations thereof. Such reactions can form modified PAHs, such as oxygenated PAHs (e.g., fluorene quinines, anthracene quinines, etc.), PASHs (e.g., enzothiophene, naphtha[2,1-b]thiophene, etc.), and nitro-PAHs (e.g., nitrofluorene, nitropyrene, etc.), respectively. The modified PAHs can bond with one another (e.g., to form one or more crosslinks from one PAH to another) via the oxygen (O), sulfur (S), and/or nitrogen (N) atoms. In other words, O, S, and/or N can modify a PAH and make the modified PAH readily able to form additional bonds with other modified PAHs. The bonds formed between the PAHs can sometimes be referred to as “crosslinks.” The modified PAHs listed above are given by way of example only and meant to be illustrative, but one of ordinary skill in the art will recognize that a vast variety of PAHs and modified PAHs exist and can be deposited onto an exterior surface of a vehicle, and the term “PAH” is used generically to refer to all PAHs, and should not be restricted to the few examples given above.

PAHs can also form bonds with metal ions (e.g., heavy metal ions) in the environment. For example, one of the modified PAHs listed above can form an ionic bond with a metal ion via the modifying element, such as O, S, or N. The metal ion can also form a bond with another PAH (e.g., by bonding with a modifying element on another PAH), and thereby form a crosslink between two or more PAHs via the metal ion. Metal ions can include, without limitation, ions of at least one of Fe, Ni, V, Cu, Zn, Cd, Pb, Ti, Cr, Sr, and combinations thereof.

PAHs, or portions or constituents thereof, can adsorb to soot in the atmosphere and get deposited on the earth's surface via rain. In addition, the PAHs can be deposited on the earth's surface by growing in particle size and weight due to collisions with other particles comprising PAH and soot. PAHs deposited on the earth's surface can be extremely oily. When PAHs are deposited on an exterior surface of a vehicle, crosslinks can form between PAHs due to exposure to the sun. Such observations are discussed below. The resulting PAH/heavy metal ion soil has a high molecular weight, and is generally very oily. Currently, the only way to remove such soil from the exterior surface of a vehicle is to use hazardous chemicals and/or friction, as mentioned above. If the oily film soil on the exterior surface of the vehicle were heated (e.g., with radiation of indiscriminate wavelengths or with too high of an energy density), the soil would likely vitrify, causing the soil to be more permanently adhered to the surface, and even more difficult to remove with touch-free vehicle cleansing procedures.

As mentioned above, crosslinks formed between PAHs can include interactions of PAHs, O, S, N, and/or metal ions. In other words, the bonds formed between PAHs can be formed by at least one of O, S, N, metal ions, and combinations thereof, or formed between at least two of O, S, N, metal ions, and combinations thereof. Nonbonding or unshared outer electrons that are largely localized about atoms such as oxygen, sulfur, and nitrogen can contribute to absorption by organic molecules. For example, the absorption bands for S, N, and O with benzene are: Thiophenol (C₆H₅SH, E₂=236 nm, B=269 nm), Aniline (C₆H₅NH₂, E₂=230 nm, B=280 nm), and Phenolate ion (C₆H₅O, E₂=235 nm, B=287 nm), respectively. Thus, the absorption bands for such crosslinks occur in the UV spectrum. The bonds formed between any of the above exemplary modifying elements and metal ions typically include absorption bands in the visible region. For example, the bond formed between NH₃ and Cr(III) has an adsorption band of about 462 nm, and the bond formed between NH₃ and Co(III) has an adsorption band of about 435 nm, both of which fall within the visible spectrum. The above absorption bands correspond to the bond energies associated with each chemical bond.

Observations have shown that a vehicle can be satisfactorily cleaned with only water in a touchless or touch-free manner as long as the vehicle has not been exposed to any precipitation (e.g., rain and/or splash-up from the road). Once the vehicle has been exposed to precipitation, a detergent is required to clean the resulting film (which commonly includes PAHs). If the vehicle experiences a sunny day subsequent to precipitation, the vehicle becomes much harder to clean. At that point, a detergent containing significant levels of oily surfactants is necessary to clean the vehicle in a satisfactory manner. Following a second daily exposure to sun, the soil on the exterior surface of the vehicle can only be satisfactorily removed with friction and/or detergents containing aggressive or hazardous chemicals, such as hydrofluoric acid. The observed change in the ability to clean the vehicle appears to be relatively independent of temperature and time elapsed between the soiling and the exposure to sun.

In some embodiments of the present invention, electromagnetic waves or radiation can be applied to a vehicle prior to performing typical cleansing procedures to break down cross-links that may have formed in the soil on the vehicle in order to facilitate subsequent cleansing procedures. In other words, electromagnetic waves can be applied to the vehicle to break specific bonds (e.g., cross-links, other covalent bonds, etc.) or disrupt or eliminate interactions (e.g., van der Waals interactions, hydrogen bonding, other non-covalent bonds, etc.) that may have occurred amongst soil molecules, or to break bonds or disrupt or eliminate interactions that may have occurred between the soil and an exterior surface of a vehicle. For simplicity, the terminology “breaking bonds” is used herein and in the appended claims to refer to breaking bonds and/or eliminating interactions, unless explicitly stated otherwise.

For example, some embodiments of the present invention include breaking crosslinks between PAHs in the soil in a directed manner to make the soil smaller (i.e., lower molecular weight), less oily, and able to be removed with touch-free vehicle cleansing procedures. In other words, some embodiments of the present invention can include irradiating an exterior surface of the vehicle with electromagnetic radiation having a wavelength that corresponds to the amount of energy needed to break the bonds or crosslinks, which improves the washability of the vehicle, and particularly, improves the washability of the vehicle with touch-free vehicle cleansing procedures. These bonds can be broken with electromagnetic radiation without heating, carbonizing, ablating, pyrolyzing, or vitrifying the soil. In addition, some embodiments of the present invention provide a method for cleaning a vehicle that includes breaking bonds within the PAHs, instead of or in addition to, breaking bonds between PAHs.

In other embodiments, electromagnetic radiation can be applied to a vehicle to cross-link the soil in a directed manner in order to break down the soil using one or more subsequent electromagnetic radiation applications. In other words, electromagnetic radiation can be applied to the vehicle to form specific bonds or interactions between soil molecules or between the soil and an exterior surface. The first exposure may be needed to ensure that all of the soil is cross-linked, or otherwise bonded or interacted, so that the one or more subsequent electromagnetic radiation applications that break down the soil are more effective. For example, some embodiments of the present invention provide a method for cleaning a vehicle that includes forming bonds between PAHs by irradiating the exterior surface of a vehicle to form crosslinks in a directed manner that can later be broken by irradiating the exterior surface of the vehicle as described above.

In still other embodiments, electromagnetic radiation can be applied to a vehicle after at least one cleansing procedure or electromagnetic radiation application to further break down the soil into benign constituents, or to break down the soil into compounds that can render hazardous chemicals benign.

The amount of ambient or natural electromagnetic radiation (i.e., sunlight) in the vehicle cleaning apparatus can be minimized to inhibit ambient electromagnetic radiation from interfering with any electromagnetic wave application from the electromagnetic wave application apparatus. In some embodiments of the present invention, the amount of ambient electromagnetic radiation can be minimized or even eliminated throughout the vehicle cleaning apparatus and throughout the vehicle cleaning process. In other embodiments, the amount of ambient electromagnetic radiation can be minimized during any electromagnetic radiation treatments but not during other cleansing procedures.

The electromagnetic waves applied to the exterior of a vehicle can have a variety of wavelengths. That is, the electromagnetic waves can have a wavelength of less than about 2000 nm, particularly, less than about 1000 nm, particularly, less than about 700 nm, and more particularly, less than about 400 nm. The electromagnetic waves can have a wavelength of greater than about 100 nm, particularly, greater than about 290 nm, and more particularly, greater than about 320 nm. By way of example only, the electromagnetic waves can have a wavelength ranging from about 100 nm to about 2000 nm (i.e., UV to IR), particularly, ranging from about 100 nm to about 700 nm (i.e., UV through visible light), and more particularly, ranging from about 290 nm to about 320 nm (i.e., UV-B), or from about 400 nm to 700 nm (i.e., visible light). For example, visible light can be used to break crosslinks between PAHs that involve metal ions.

By way of further example, a variety of crosslinks that occur between modifying elements on PAHs have absorption bands in the UV spectrum. As mentioned above, this means the bond energies associated with such chemical bonds or crosslinks can be broken by being irradiated with a corresponding amount of energy delivered by electromagnetic radiation having a wavelength in the UV spectrum. The absorption bands can range from about 100 nm to about 400 nm, particularly, from about 200 nm to about 400 nm, and more particularly, from about 230 nm to about 310 nm. As a result, the electromagnetic waves used to irradiate an exterior surface of a vehicle can also have a wavelength within these ranges to effectively break the chemical bonds between PAHs having corresponding bond energies. Because such bonds are responsive to such electromagnetic radiation, the bonds can be broken using electromagnetic radiation in a directed manner.

In addition to the wavelength of the radiation, the following parameters may be considered to optimize the breakdown of the soil on the vehicle: the energy density (i.e., energy per unit area) required to break down the soil (E/A)_{act} the light intensity I, the total irradiation time Δtₜₒₜ, and the surface area of the vehicle to be irradiated A_{surf}, wherein the energy density (E/A)_{act} is, for example, in units of lumen·hours/m², the light intensity I is, for example, in units of lumens, the total irradiation time Δtₜₒₜ is reported in units of seconds, and the surface area A_{surf} is, for example, in units of m². The parameters are interrelated according to the following equation.

(E/A)_{act}=(I×Δtₜₒₜ)/A_{surf} (Eq. 1)

Therefore, given a desired energy density (E/A)_{act}, a surface area of the vehicle to be irradiated A_{surf}, and a desired total irradiation time Δtₜₒₜ, the necessary light intensity I can be calculated. Once the light intensity I has been calculated in lumens, the appropriate luminous efficacy conversion factor can be used to convert from lumens (lm) to watts (W) if the wavelength (e.g., in nm) is known (e.g., 1 W=683 lm at a wavelength of 555 nm). As a point of reference, a 20 J/cm² exposure of 555 nm radiation for 400 microseconds would equal 3.278 million lumen·hours/m².

The electromagnetic waves applied to the surface of a vehicle can be applied at various energy densities (E/A)_{act} (e.g., in lumen·hours/m²). As used herein and in the appended claims, a “lumen·hour” is a unit of quantity of light that is equal to one lumen of light flux continued for one hour. The electromagnetic waves can have an energy density (E/A)_{act}, reported in lumen·hours/m², of at least about 1 lumen·hour/m², particularly, at least about 100 lumen·hours/m² and more particularly, at least about 1,000 lumen·hours/m². The electromagnetic waves can have an energy density (E/A)_{act} of less than about 10,000 lumen·hours/m², particularly, less than about 1,000 lumen·hours/m², and more particularly, less than about 250 lumen·hours/m². Such energy densities correspond to electromagnetic radiation having a specific range of wavelengths.

The electromagnetic waves applied to the exterior of a vehicle can be applied for a variety of total irradiation times Δtₜₒₜ. For example, the electromagnetic waves can be applied for less than about 180 seconds, particularly, less than about 60 seconds, particularly, less than about 30 seconds, and more particularly, less than about 1 second. Alternatively, the electromagnetic waves can be applied for greater than about 0.001 seconds, particularly, greater than about 0.1 seconds, particularly, greater than about 0.2 seconds, and more particularly, greater than about 0.5 seconds. It should be understood that electromagnetic waves can be applied for longer periods of time than those specifically discussed above, but that shorter durations for electromagnetic radiation application will decrease the overall car wash time.

The electromagnetic waves applied to the exterior of a vehicle can be applied from a variety of distances from an exterior surface of the vehicle. For example, the electromagnetic waves can be applied from at least about 0.5 ft from a surface of the vehicle, particularly, from at least about 1.0 ft from a surface of the vehicle, and more particularly, from at least about 1.5 ft from a surface of the vehicle. Alternatively, the electromagnetic waves can be applied from less than about 15 ft from a surface of the vehicle, particularly, from less than about 10 ft from a surface of the vehicle, and more particularly, from less than about 5 ft from a surface of the vehicle.

Several different forms of electromagnetic waves can be applied sequentially or simultaneously to the exterior of a vehicle in order to break down (or crosslink in a directed manner) a variety of soil types. For example, depending on the binding energy between various elements and compounds that make up the soil, UV-B radiation can be applied to a first portion of the exterior of a vehicle, and visible light can be applied simultaneously or sequentially to a second portion of the exterior of the vehicle. In addition, different surfaces and materials on the exterior of a vehicle may require different electromagnetic radiation application regimes based on different interactions, bonding and coefficients of friction that may occur between various types of soil and the variety of surfaces and materials on the exterior of the vehicle. For example, glass surfaces may require different electromagnetic radiation treatment than painted surfaces of the vehicle, because soil types that adhere to a glass surface may be different from soil types that adhere to a painted surface, or similar soil types may interact differently with a glass surface than with a painted surface.

In some embodiments, different electromagnetic radiation application regimes can be scanned sequentially over the vehicle. By scanning a variety of electromagnetic radiation applications over the vehicle, it is not necessary to know what type of soil (e.g., what bonding or interactions have occurred amongst soil molecules or between soil molecules and the exterior surface of the vehicle) is present on the exterior surface of the vehicle to effectively clean the vehicle. For example, in some embodiments, a series of electromagnetic radiation applications can be scanned sequentially over a vehicle with wavelengths ranging from about 100 nm to about 1000 nm. In some embodiments, a series of electromagnetic radiation applications can be scanned sequentially over a vehicle with wavelength ranging from about 100 nm to about 700 nm. In some embodiments, a series of electromagnetic radiation applications can be scanned sequentially over a vehicle with wavelengths ranging from about 400 nm to about 700 nm. In some embodiments, a series of electromagnetic radiation applications can be scanned sequentially over a vehicle with wavelengths ranging from about 290 nm to about 320 nm.

However, if the soil type is known, the vehicle can be scanned with a specific set of wavelengths to tailor the electromagnetic application to a specific type of soil, or variety of soils. For example, because soil can be made up of a variety of PAHs and metal ions, and that the mechanism for release can be the absorption of energy from a specific wavelength of electromagnetic radiation, electromagnetic radiation specific to crosslinks between PAHs (e.g., via a metal ion or not) or bonds within PAHs can be applied to the exterior surface of the vehicle. However, because soil can include a vast array of PAHs, the exterior surface of the vehicle may need to be scanned with a series of electromagnetic radiation applications within the ranges of specific wavelengths in order to account for all the PAHs and metal ions that may be present. For example, a first series of electromagnetic radiation applications can be scanned sequentially over a vehicle with wavelengths ranging from about 400 nm to about 700 nm to break crosslinks between PAHs that involve metal ions. Subsequently, a second series of electromagnetic radiation applications can be scanned sequentially over a vehicle with wavelengths ranging from about 100 nm to about 400 nm to break crosslinks between PAHs that involve at least one of O, S, N, and combinations thereof.

In some embodiments, the wavelength of the electromagnetic radiation can be incremented or decremented throughout a specified range of wavelengths by tenths of nanometers, or by some other denomination (e.g., by halves of nanometers, etc.). In some embodiments, a series of wavelengths within a specified range of wavelengths can be applied in any order (e.g., an electromagnetic radiation application having a wavelength of about 100 nm, followed by an electromagnetic radiation application having a wavelength of about 700 nm, followed by an electromagnetic radiation application having a wavelength of 400 nm, etc.). In other words, the series or plurality of electromagnetic radiation applications do not have to increase or decrease in wavelength, but can be applied randomly. Combinations of the above may also be employed.

The duration of a sequential scanning process can vary, depending on how long each electromagnetic radiation application is applied to the vehicle. As described above, each application of electromagnetic radiation can occur for a period of less than about 180 seconds, particularly, less than about 60 seconds, particularly, less than about 30 seconds, and more particularly, less than about 1 second. Alternatively, each application of electromagnetic radiation can occur for a period of greater than about 0.001 seconds, particularly, greater than about 0.1 seconds, particularly, greater than about 0.2 seconds, and more particularly, greater than about 0.5 seconds. The duration of a sequential scanning process can then be determined based on how many different electromagnetic radiation applications are applied, and the duration of each electromagnetic radiation application.

In some embodiments of the present invention, a first form of electromagnetic radiation can be applied to the entire exterior of a vehicle, followed by an application of a second form of electromagnetic radiation to the entire exterior of a vehicle to break down various types of soil bonds that may occur on a variety of surfaces and materials on the exterior of a vehicle.

In some embodiments of the present invention, a variety of electromagnetic radiation can be applied locally (simultaneously or sequentially) to various portions of the exterior of the vehicle to treat specific soil types. In addition, specific types of electromagnetic radiation can be applied to various portions of the vehicle depending on the identification of different soil types on different portions of the vehicle. For example, a first type of soil can be identified as being present on a first portion of a vehicle, and a second type of soil can be identified as being present on a second portion of the vehicle. Different local electromagnetic radiation treatments can then be applied to the first and second portions of the vehicle, depending on the soil types identified.

In some embodiments, the electromagnetic radiation can be applied to the vehicle in a continuous, non-pulsed mode. In other embodiments, the electromagnetic radiation can be pulsed at a variety of frequencies to break (or create) bonds in a directed manner for a variety of soil types on the exterior surface of the vehicle.

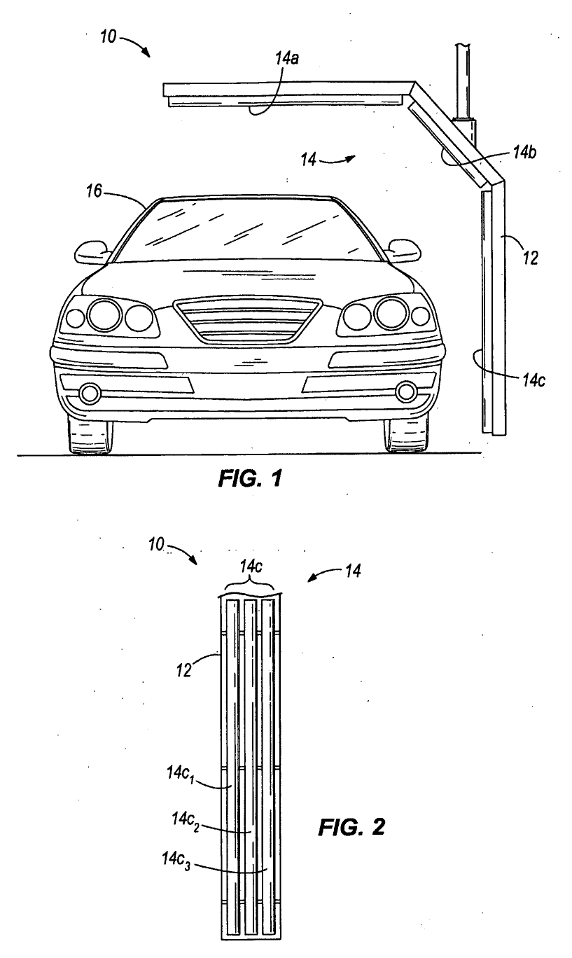

FIGS. 1-6 show various embodiments of the vehicle cleaning apparatus of the present invention, and particularly, various embodiments of the electromagnetic wave application apparatus. FIGS. 1 and 2 illustrate an electromagnetic wave application apparatus 10 according to a first embodiment of the present invention. As shown in FIG. 1, the electromagnetic wave application apparatus 10 includes a frame 12 having a generally inverted “L” shape and an electromagnetic radiation source 14. In some embodiments, as shown in FIG. 1, the electromagnetic radiation source 14 is defined by one or more sections, which are arranged about a vehicle 16.

The electromagnetic radiation source 14 illustrated in FIG. 1 includes three sections, namely, a first section 14a, a second section 14b, and a third section 14c. The first section 14a is coupled to an upper portion of the frame 12, such that the first section 14a is positioned substantially horizontally above the vehicle 16 during use. The second section 14b is coupled to an intermediate portion of the frame 12, such that the second section 14b is positioned generally diagonally over an upper edge of the vehicle 16 during use. The third section 14c is coupled to a lower portion of the frame 12, such that the third section 14c is position substantially vertically and adjacent a side of the vehicle 16 during use. It should be understood that the electromagnetic radiation source 14 can alternatively be defined by one continuous section that curves around a side and upper surface of the vehicle 16, by more than three sections, by one relatively straight section that is moved over an upper surface of the vehicle 16 and around all sides of the vehicle 16, or the electromagnetic radiation source 14 can be arranged and oriented with respect to the vehicle 16 in a variety of other manners.

The electromagnetic radiation source 14 shown in FIG. 1 is coupled to the frame 12 such that the vehicle 16 can be maintained in a stationary position while the frame 12 and electromagnetic radiation source 14 are moved around all sides of the vehicle 16 to allow the electromagnetic radiation source 14 to treat the outer surfaces of the vehicle 16.

In some embodiments, the frame 12 and electromagnetic radiation source 14 are moved toward the vehicle to a first position located near the left side of the front of the vehicle. For example, in the first position, the frame 12 and electromagnetic radiation source 14 can be positioned such that the first section 14a is about 1 ft above the highest point of the vehicle and the third section 14c is about 1 ft from the left side of the front of the vehicle. The frame 12 and electromagnetic radiation source 14 can then move along the left side of the vehicle, while emitting electromagnetic radiation, to a second position located near the left side of the rear of the vehicle. For example, in the second position, the frame 12 and the electromagnetic radiation source 14 can be positioned such that the first section 14a remains about 1 ft above the highest point of the vehicle, and the third section 14c is about 1 ft from the left side of the rear of the vehicle. One or both of the frame 12 and electromagnetic radiation source 14 can then pivot at the second position, continue emitting the electromagnetic radiation, and begin moving along the rear end of the vehicle to a third position. The third position can be located on the right side of the vehicle, approximately symmetrically opposite the vehicle from the second position. The frame 12 and the electromagnetic radiation source 14 can then pivot at the third position, continue emitting the electromagnetic radiation, and begin moving along the right side of the vehicle to a fourth position. The fourth position can be located on the right side of the vehicle, approximately symmetrically opposite the vehicle from the first position. The frame 12 and the electromagnetic radiation source 14 can then pivot in the fourth position, continue emitting the electromagnetic radiation, and return to the first position. In some embodiments, a first frame 12 and electromagnetic radiation source 14 can move about the vehicle in the above-described path, and then can move out of the way to allow second frame 12 and electromagnetic radiation source 14 to be moved into the first position, and subsequently moved around the vehicle. This path is merely illustrative, and one of ordinary skill in the art will appreciate that the electromagnetic wave application apparatus 10 can move about the vehicle along a different path than the one described above.

FIG. 2 shows a partial side view of the electromagnetic wave application apparatus 10. Specifically, FIG. 2 illustrates a side view of the third section 14c of the electromagnetic radiation source 14. In some embodiments, the electromagnetic radiation source 14 can include more than one type of electromagnetic radiation to allow simultaneous or sequential treatment of a variety of soil conditions. For example, FIG. 2 illustrates the third section 14c as being formed of three electromagnetic radiation sources, namely, a first section 14c₁, a second section 14c₂ and a third section 14c₃. The first section 14a and the second section 14b can have similar radiation sources (not shown). It should be understood that as few as one electromagnetic radiation source 14 and as many as desired can be used in the vehicle cleaning apparatus 100.

In some embodiments, the three electromagnetic radiation sources 14c₁, 14c₂ and 14c₃ can emit electromagnetic radiation simultaneously as the electromagnetic wave application apparatus 10 is moved about the vehicle 16 (as shown in FIG. 1). In other embodiments, the three electromagnetic radiation sources 14c₁, 14c₂ and 146₃ can be controlled such that a different electromagnetic radiation source 14c₁, 14c₂ or 14c₃ (or combinations thereof) is used for different portions of the vehicle 16. For example, the first electromagnetic radiation source 14c₁ can be activated when the electromagnetic wave application apparatus 10 is moved over a first type of soil, or a first type of vehicle surface (e.g., glass, painted surface, etc.). Subsequently, the first electromagnetic radiation source 14c, can be deactivated and the second electromagnetic radiation source 14c₂ can be activated when the electromagnetic wave application apparatus 10 is moved over a second type of soil or second type of vehicle surface, and so on.

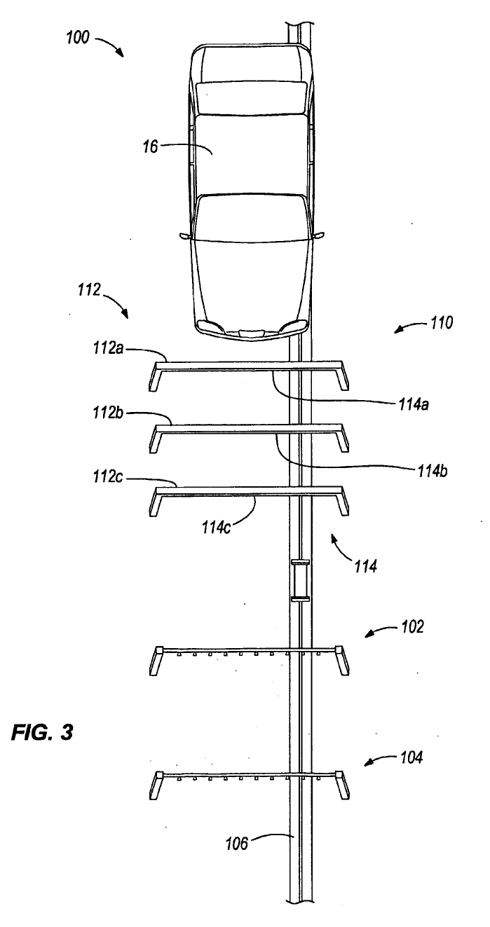

FIG. 3 illustrates an electromagnetic wave application apparatus 110 according to a second embodiment of the present invention. The electromagnetic wave application apparatus 100 is shown as a subassembly of a vehicle cleaning apparatus 100, including a detergent application station 102, a high pressure wash station 104, and a track 106, along which the vehicle 16 can be moved through the vehicle cleaning apparatus 100. In some embodiments, as illustrated in FIG. 3, the electromagnetic wave application apparatus 100 is stationary and includes one or more frames 112 having a generally inverted “U” shape. The one or more frames 112 can each be formed of one continuously curved frame 112, or the one or more frames 112 can be formed of more than one relatively straight portion arranged to form a generally inverted “U” shape. While the electromagnetic application apparatus 110 is illustrated as being positioned ahead of the detergent application station 102, the electromagnetic application apparatus 110 can be positioned at any point in the vehicle cleaning apparatus 100.

As shown in FIG. 3, the electromagnetic wave application apparatus 110 includes three frames 112, namely, a first frame 112a, a second frame 112b and a third frame 112c. Coupled to each frame 112, is an electromagnetic radiation source 114, namely, a first electromagnetic radiation source 114a, a second electromagnetic radiation source 114b and third electromagnetic radiation source 114c. Each electromagnetic radiation source 114a, 114b or 114c can be formed of one or more sections, as explained above.

In some embodiments, the electromagnetic radiation sources 114a, 114b and 114c can all emit the same type of electromagnetic radiation. In other embodiments, the electromagnetic radiation sources 114a, 114b and 114c can each emit a different type of electromagnetic radiation. For example, after a portion of the vehicle 16 has been treated by the first electromagnetic radiation source 114a, the vehicle 16 has moved (via the track 106) into position to be treated by the second electromagnetic radiation source 114b, and so on, until all of the outer surfaces of the vehicle 16 have been treated with each type of electromagnetic radiation source 114a, 114b and 114c. It should be understood, however, that it is not required that each vehicle 16 be treated by all of the electromagnetic radiation sources 114a, 114b and 114c, but rather, a specific combination of electromagnetic radiation sources 114a, 114b and 114c can be selected to treat each vehicle 16.

The electromagnetic radiation sources 114a, 114b and 114c of the embodiment illustrated in FIG. 3 are positioned about 1-2 ft apart. However, it should be understood that in other embodiments, a smaller or larger separation distance can be used. In addition, FIG. 3 illustrates three electromagnetic radiation sources 114a, 114b and 114c, but it should be understood that as few as one electromagnetic radiation source 114 and as many as desired can be used in the vehicle cleaning apparatus 100.

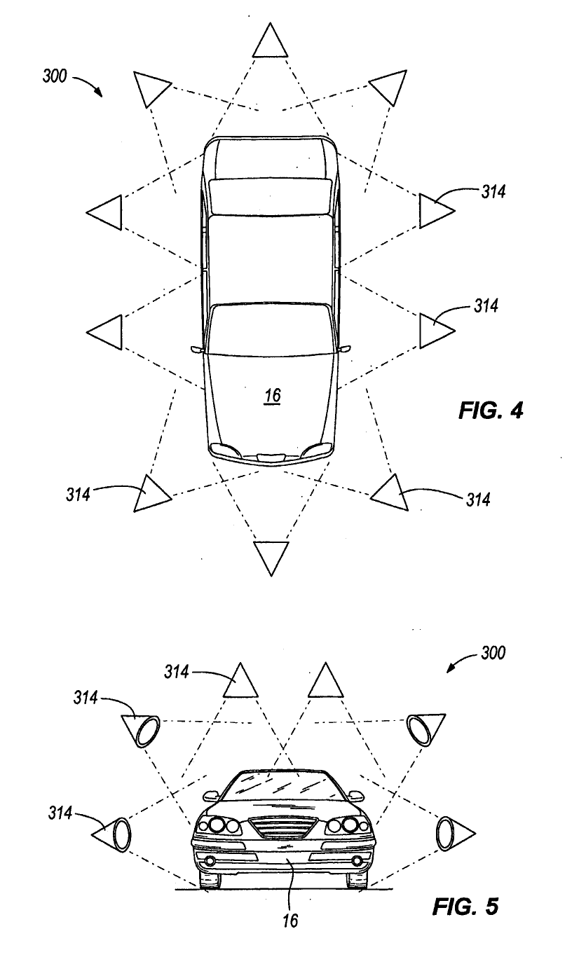

FIGS. 4 and 5 illustrate an electromagnetic wave application apparatus 300 according to a third embodiment of the present invention. As shown in FIGS. 4 and 5, a plurality of electromagnetic radiation sources 314 can be positioned around all sides of the vehicle 16 and above the vehicle 16 (electromagnetic radiation sources 314 positioned above the vehicle 16 have been removed from FIG. 4 for clarity, and electromagnetic radiation sources 314 positioned in front of the vehicle 16 have been removed from FIG. 5 for clarity). In some embodiments, the electromagnetic radiation sources 314 can all emit the same type of electromagnetic radiation. In other embodiments, the electromagnetic radiation sources 314 can each emit a different type of electromagnetic radiation. In still other embodiments, the plurality of electromagnetic radiation sources 314 is formed of one or more subsets of electromagnetic radiation sources, in which each subset of electromagnetic radiation sources 14 emits a particular type of electromagnetic radiation. For example, one subset of electromagnetic radiation sources 314 can emit one type of electromagnetic radiation to treat glass windows of the vehicle 16, while another subset of electromagnetic radiation sources 314 can emit another type of electromagnetic radiation to treat painted surfaces of the vehicle 16.

In some embodiments, the electromagnetic radiation sources 314 can be movable toward and away from the vehicle 16 to allow electromagnetic radiation application from a variety of sources positioned various distances from the exterior of the vehicle 16. The distances the electromagnetic radiation sources 314 are spaced from the outer surface of the vehicle 16 can be determined individually for each vehicle 16.

By way of example only, the vehicle 16 can be driven into a vehicle cleaning apparatus and stopped at a predetermined position. A variety of subsets of electromagnetic radiation sources 314 (e.g., custom-selected for each vehicle 16) can be moved toward the vehicle 16 into position to treat various outer surfaces of the vehicle 16. The types (or combinations of types) of electromagnetic radiation, the number of subsets, the number of electromagnetic radiation sources 314 in each subset, and the distance between any electromagnetic radiation source 314 and an outer surface of the vehicle 16 can be determined by the type of vehicle 16, the type of soil, the extent to which the vehicle 16 is soiled, and a variety of other factors.

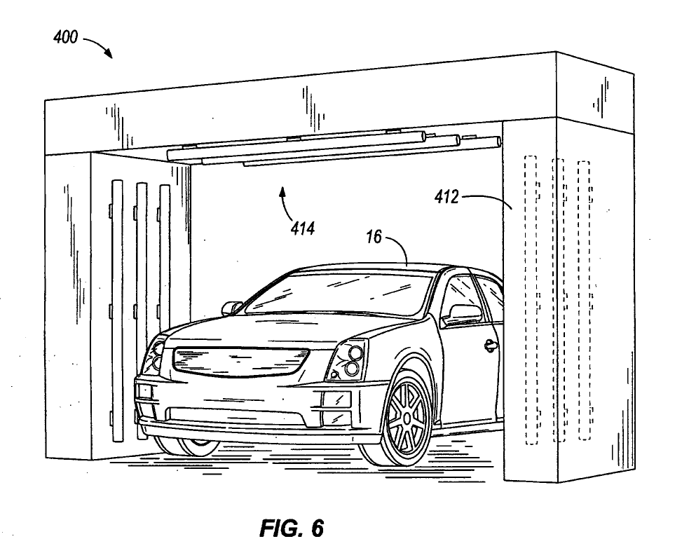

FIG. 6 illustrates an electromagnetic wave application apparatus 400 according to a fourth embodiment of the present invention. The electromagnetic wave application apparatus 400 includes a gantry frame 412 and electromagnetic radiation sources 414. In some embodiments, the gantry frame 412 can be moved forward and back over the vehicle 16. In other embodiments, the vehicle 16 can be driven underneath the gantry frame 412. In still other embodiments, the vehicle 16 can be moved underneath the gantry frame 412 along a track (as shown in FIG. 3).

Prophetic examples 1-6 relating to the present invention are discussed below. Any of the below examples can be used alone or in combination to treat a vehicle with electromagnetic radiation. The most effective parameters for treating a vehicle with electromagnetic radiation are expected to depend on the type of vehicle, the type of soil, and the extent to which the vehicle is soiled, as well as other external conditions (e.g., weather, etc.). The present invention can comprise any combination of the electromagnetic wave application apparatuses 10, 100, 300, 400 illustrated in FIGS. 1-6 and any of the wavelengths; irradiation times, application distances and energy densities described above without departing from the spirit and scope of the present invention. The following examples include prophetic and working examples, and are intended to be illustrative and not limiting.

### EXAMPLE 1

An initial application of electromagnetic radiation is applied to the vehicle to cross-link the soil in a directed manner. The vehicle cleaning apparatus is configured as shown in FIG. 5 with approximately ten sources irradiating the vehicle with electromagnetic radiation having a wavelength in the UV-B spectrum (e.g., about 290 nm to about 320 nm, and particularly, about 305 nm; testing is done in 5-nm intervals within the range of about 290 nm to about 320 nm). The electromagnetic radiation is applied in a continuous, non-pulsed mode.

The energy density (E/A)_{act} of the electromagnetic radiation at the surface of the vehicle, reported in lumen·hours/m², is from about 200 lumen·hours/m² to about 300 lumen·hours/m² at the surface of the vehicle, and particularly, about 250 lumen·hours/m². Testing is done at intervals of 20 lumen·hours/m² within the range of about 200 lumen·hours/m² to about 300 lumen·hours/m² (e.g., 200 lumen·hours/m², 220 lumen·hours/m², 240 lumen·hours/m², etc.). Assuming each electromagnetic radiation source irradiates approximately 4 m² of the vehicle surface (A_{surf}), and the radiation is exposed for a total irradiation time Δtₜₒₜ of 30 seconds, the necessary light intensity I is calculated using Eq. 1 and the appropriate luminous efficacy conversion factor (if necessary), as is well-known to those of ordinary skill in the art.

Next, an application of electromagnetic radiation having a wavelength in the visible spectrum (e.g., about 400 nm to about 700 nm, and particularly, about 555 nm; testing is done at 20-nm intervals within the range of about 400 nm to about 700 nm) with a similar energy density (E/A)_{act} and total irradiation time Δtₜₒₜ is applied to the vehicle to break down the soil in a directed manner. A detergent application is made, and the vehicle is rinsed off with high pressure water.

### EXAMPLE 2

An initial application of electromagnetic radiation is applied to the vehicle to break the bonds of the soil in a directed manner. The vehicle cleaning apparatus is configured as illustrated in FIG. 1 with an inverted “L” source irradiating the vehicle with electromagnetic radiation having a wavelength in the visible spectrum (e.g., about 400 nm to about 700 nm, and particularly, about 565 nm; testing is done at 20-nm intervals within the range of about 400 nm to 700 nm). The electromagnetic radiation is applied in a continuous, non-pulsed mode.

The energy density (E/A)_{act} of the electromagnetic radiation is from about 450 lumen·hours/m² to about 550 lumen·hours/m², and particularly, about 500 lumen·hours/m² at the surface of the vehicle. Testing is done at intervals of 20 lumen·hours/m² within the range of about 450 lumen·hours/m² to about 550 lumen·hours/m². The application of electromagnetic radiation occurs for a total irradiation time Δtₜₒₜ of less than 5 seconds, and may be tested at one-second intervals. The application is within 18-36 inches of the vehicle. The 6-foot long source covers an area of less than 6 inches in width. One of ordinary skill in the art determines the surface area of the vehicle to be irradiated, A_{surf}. The necessary light intensity I is calculated using Eq. 1 and the appropriate luminous efficacy conversion factor (if necessary), as is well-known to those of ordinary skill in the art. A detergent application is made, and the vehicle is rinsed off with high pressure water.

### EXAMPLE 3

An initial application of two or more wavelengths of electromagnetic radiation is applied to the vehicle to cross-link the soil in a directed manner. The vehicle cleaning apparatus is configured as illustrated in FIG. 3, with arches of electromagnetic radiation sources irradiating the vehicle with electromagnetic radiation of a specific wavelength for each surface. For example, the electromagnetic radiation can have a wavelength in the UV-B spectrum (e.g., about 290 nm to about 320 nm, and particularly 300 nm for painted surfaces, and 295 nm for glass surfaces; testing is done for each type of surface at 5-nm intervals within the range of about 290 nm to about 320 nm). The electromagnetic radiation is applied in a continuous, non-pulsed mode.

The energy density (E/A)_{act} of the electromagnetic radiation is from about 50 lumen·hours/m² to about 150 lumen·hours/m² at the surface of the vehicle, and particularly, 100 lumen·hours/m². Testing is done at intervals of 20 lumen·hours/m² within the range of about 50 lumen·hours/m² to about 150 lumen·hours/m². The electromagnetic radiation application occurs for a total irradiation time Δtₜₒₜ of less than 1 second, and may be tested in intervals of 0.1 seconds. The application is within 18-36 inches of the vehicle. The 6-foot long source covers an area of less than 6 inches in width. One of ordinary skill in the art determines the surface area of the vehicle to be irradiated, A_{surf}. The necessary light intensity I is calculated using Eq. 1 and the appropriate luminous efficacy conversion factor (if necessary), as is well-known to those of ordinary skill in the art.

Next, an application of two or more wavelengths of electromagnetic radiation of specific wavelengths is applied to the vehicle through the next arch (with a similar energy density (E/A)_{act} and total irradiation time Δtₜₒₜ) to break down the soil in a directed manner depending on surface. For example, the electromagnetic radiation can have a wavelength in the visible or near-infrared spectrum (e.g., about 400 nm to about 800 nm, and particularly, about 600 nm for paint surfaces, and about 650 nm for glass surfaces; testing is done for each type of surface at 20-nm intervals within the range of about 400 nm to about 800 nm). A detergent application is made, and the vehicle is rinsed off with high pressure water.

### EXAMPLE 4

An initial application of two or more wavelengths of electromagnetic radiation is applied to the vehicle to cross-link the soil in a directed manner. The vehicle cleaning apparatus is configured as illustrated in FIG. 6 with a gantry system having arches of electromagnetic radiation sources.

The vehicle is irradiated with electromagnetic radiation having a wavelength in the UV-B spectrum (e.g., about 290 nm to about 320 nm, and particularly, about 300 nm for painted surfaces, and about 295 nm for glass surfaces; testing is done for each type of surface at 5-nm intervals in the range of about 290 nm to about 320 nm). The electromagnetic radiation is applied in a continuous, non-pulsed mode.

The energy density (E/A)_{act} of the electromagnetic radiation is from about 950 lumen·hours/m² to about 1050 lumen·hours/m² at the surface of the vehicle, and particularly, about 1000 lumen·hours/m². The electromagnetic radiation application occurs for a total irradiation time Δtₜₒₜ of less than 5 seconds, and may be tested at one-second intervals. The application is within 18-36 inches of the vehicle. The 6-foot source covers an area of less than 3 inches in width. One of ordinary skill in the art determines the surface are of the vehicle to be irradiated, A_{surf}. The necessary light intensity I is calculated using Eq. 1 and the appropriate luminous efficacy conversion factor (if necessary), as is well-known to those of ordinary skill in the art.

The second set of electromagnetic radiation sources (located in the next arch) delivers an application of two or more wavelengths of electromagnetic radiation (with a similar energy density (E/A)_{act} and total irradiation time Δtₜₒₜ) to the vehicle to break down the soil in a directed manner depending on surface. For example, the electromagnetic radiation can have a wavelength in the visible or near-infrared spectrum (e.g., about 400 nm to about 800 nm, and particularly, about 600 nm for painted surfaces, and about 650 nm for glass surfaces; testing is done for each type of surface at 20-nm intervals within the range of about 400 nm to about 800 nm).

The third set of electromagnetic radiation sources applies an electromagnetic radiation to render the resulting soil safe for human contact. A detergent application is made, and the vehicle is rinsed off with high pressure water.

### EXAMPLE 5

The vehicle is swabbed on various surfaces, and the soil is put into a machine to determine the necessary electromagnetic radiation application parameters to cross-link the soil, break down the soil, and render the soil non-hazardous. Accordingly, one or more test vehicles are then subjected to electromagnetic radiation applications of various wavelengths and energy densities (E/A)_{act} for specific total irradiation times Δtₜₒₜ to cross-link the soil, break down the soil, and render the soil non-hazardous. The one or more test vehicles and one or more control vehicles are then cleaned with a detergent application, and the test vehicles and control vehicles are rinsed off with high pressure water.

The improved washability of the test vehicles resulting from the electromagnetic radiation applications is determined, as compared to control vehicles that were washed without being exposed to the electromagnetic radiation applications.

The soil remaining on the test vehicles, as compared to control vehicles, is determined by contacting the surfaces of the test vehicles and the control vehicles with an object (e.g., a swab, a finger, etc.) and inspecting the object for visible signs of soil.

In addition to, or in lieu of, contacting the surfaces of the vehicles with the object, a measuring device (e.g., a reflectometer or gloss meter) is used to determine the level of cleanliness for the test vehicles and the control vehicles.

The dryness of the surface of the test vehicles, as compared to control vehicles, is tested after a drying agent is applied. If the surface has a layer of road film, the drying agent will stick in such a fashion as to hold water to the surface. If the surface is clean, the drying agent will repel water.

The soil that is removed from the test vehicles and the control vehicles is captured in a drain and analyzed to establish that the resulting chemical is non-hazardous. In addition, the chemical analysis of the soil removed from the test vehicles can be to compared to that of the control vehicles to determine the effectiveness of the electromagnetic radiation application in rendering the soil non-hazardous.

### EXAMPLE 6

A plurality of electromagnetic radiation applications is scanned over the exterior surface of a vehicle beginning at a wavelength of about 100 nm and incremented by tenths of nanometers to a wavelength of about 1000 nm over a period of about 3 minutes. Each electromagnetic radiation application is applied to the exterior surface of the vehicle for a period of time before the subsequent electromagnetic radiation application is applied. The series of electromagnetic radiation applications is performed prior to, during, or subsequent to any cleansing procedures, or combinations thereof.

### EXAMPLE 7

An initial application of electromagnetic radiation was applied to the vehicle to break the bonds of the soil in a directed manner. The soil was cross-linked by driving the vehicle in a rainstorm and allowing it to experience 2 sunny days. The apparatus was a PX-2 Pulsed Xenon Light Source from Ocean Optics. The light was transmitted through a 600-μm, solarization-resistant optical fiber (available from Ocean Optics, Item code P600-1-SR) and passed through a single high-pass linear variable filter (300-750 nm). The vehicle was irradiated with a 15-nm range of electromagnetic radiation having a wavelength within the range of about 300 nm to about 750 nm at 15-nm intervals. The 15-nm intervals were achieved by manually adjusting the filter. The electromagnetic radiation of 45 milli-Joules/pulse was applied 5 minutes (i.e., 1/12 hour) over about one square centimeter surface of the vehicle (0.045 J/cm²). These exposure points were spaced 6 inches apart down the side of the vehicle. The pulses occur 5 times/second which results in 0.225 W.

The energy density (E/A)_{act} of the electromagnetic radiation was about 187.5 W·hours/m² (0.225 W× 1/12 hour×10,000 cm²/m²=187.5 W·hours/m²). This was equal to approximately 50.6 lumen·hours/m² at 400 nm (the luminous efficiency at 400 nm is 0.27; 187.5 W·hours/m²×0.27 lumens/watts=50.6 lumen·hours/m²). A detergent application was made, and the vehicle was rinsed off with low pressure water.

A drying agent was applied and rinsed off in order to determine the cleanliness of the vehicle. Upon observation, the portions of the vehicle that were irradiated with lower wavelengths were cleaner than the portions of the vehicle that were irradiated with high wavelengths, and were gradually dirtier at the increasingly higher wavelengths. Also, the cleanliness of the exterior surface of the vehicle was not restricted to the area of application but was also affected away from the point of irradiation. This is believed to be due, at least in part, to the fact that the soil was a liquid (“soup”).

Various features and aspects of the invention are set forth in the following claims.

What is claimed is:

1. A method of cleaning a vehicle, the method comprising:
irradiating an exterior surface of the vehicle with artificial electromagnetic radiation, the exterior surface of the vehicle having soil deposited thereon, the soil comprising a plurality of PAHs, at least some of the plurality of PAHs being bonded together via a chemical bond having a bond energy, the chemical bond being formed between at least two of O, S, N, and a metal ion; and
breaking the chemical bond with the artificial electromagnetic radiation, the artificial electromagnetic radiation having a predetermined wavelength that corresponds to the energy required to break the chemical bond; and
cleaning the vehicle.

2. The method of claim 1, wherein the plurality of PAHs includes at least one of acenaphthene, acenaphthylene, acephenanthrylene, anthanthrene, anthracene, benzo[a]coronene, benzo[a]naphthacene, benzo[a]pyrene, benzo[b]chrysene, benzo[b]fluorene, benzo[c]chrysene, benzo[c]phenanthrene, benzo[e]pyrene, benzo[ghi]fluoranthene, benzo[ghi]naphtha[cde]perylene, benzo[ghi]perylene, benzo[j]fluoranthene, benzo[rst]dinaphtho[defg,ijkl]pentaphene, benzo[rst]phenanthro[1,10,9-cde], benz[a]anthracene, benz[e]acephenanthrylene, benz[rst]anthra[cde]pentaphene, chrysene, coronene, cyclopenteno[cd]pyrene, dibenzo[b,def]chrysene, dibenzo[bc,ef]coronene, dibenzo[cd,lm]perylene, dibenzo[g,p]chrysene, dibenzo[j,lm]naphtha[ab]perylene, dibenz[a,c]anthracene, dibenz[a,h]anthracene, dibenz[a,j]anthracene, dinaphtho[defg,opqr]pentacene, fluoranthene, fluorene, hexabenzo[a,cd,f,j,lm,o]perylene, naphthacene, naphthalene, naphtho[a]anthracene, naphtho[bcd]perylene, naphtho[d]coronene, pentabenzo[a,cd,f,j,lm]perylene, pentacene, pentaphene, perylene, phenanthrene, phenanthro[3,4-c]phenantrene, picene, pyranthrene, pyrene, tetrabenzo[a,cd,f,lm]perylene, triphenylene, and combinations thereof.

3. The method of claim 1, wherein the metal ion includes an ion of at least one of Fe, Ni, V, Cu, Zn, Cd, Pb, Ti, Cr, Sr, and combinations thereof.

4. The method of claim 1, wherein the predetermined wavelength ranges from about 100 nm to about 700 nm.

5. The method of claim 1, wherein the predetermined wavelength ranges from about 230 nm to about 310 nm.

6. The method of claim 1, wherein the plurality of PAHs includes at least one of a PASH, an oxygenated PAH, a nitro-PAH, and a combination thereof.

7. The method of claim 1, wherein cleaning the vehicle includes cleaning the vehicle without using friction or hazardous chemicals.

8. The method of claim 1, wherein cleaning the vehicle includes:
applying detergent to the exterior surface of the vehicle in a touch-free manner after breaking the chemical bond; and
rinsing the detergent from the exterior surface of the vehicle in a touch-free manner.

9. The method of claim 1, wherein breaking the chemical bond includes breaking the chemical bond without substantially heating, carbonizing, ablating, pyrolyzing, or vitrifying the soil.

10. The method of claim 1, further comprising forming the chemical bond by irradiating the exterior surface of the vehicle with electromagnetic radiation having a wavelength that corresponds to the energy required to form the chemical bond.

11. The method of claim 1, further comprising breaking a chemical bond within at least one of the plurality of PAHs.

12. A method of cleaning a vehicle, the method comprising:
emitting artificial electromagnetic radiation toward an exterior surface of the vehicle, the exterior surface of the vehicle having soil deposited thereon, the soil comprising a plurality of PAHs, at least some of the plurality of PAHs being bonded together via a chemical bond having a bond energy, the artificial electromagnetic radiation having a predetermined wavelength that corresponds to the bond energy of the chemical bond; and
breaking the chemical bond with the artificial electromagnetic radiation without substantially pyrolyzing the soil.

13. The method of claim 12, wherein the chemical bond is formed between at least two of O, S, N and a metal ion.

14. The method of claim 13, wherein the metal ion includes an ion of at least one of Fe, Ni, V, Cu, Zn, Cd, Pb, Ti, Cr, Sr, and combinations thereof.

15. The method of claim 12, wherein the predetermined wavelength ranges from about 100 nm to about 700 nm.

16. The method of claim 12, wherein the predetermined wavelength ranges from about 230 nm to about 310 nm.

17. The method of claim 12, wherein the plurality of PAHs includes at least one of a PASH, an oxygenated PAH, a nitro-PAH, and a combination thereof.

18. The method of claim 12, further comprising cleaning the vehicle with touch-free vehicle cleansing procedures after breaking the chemical bond.

19. The method of claim 12, further comprising:
applying a detergent to the exterior surface of the vehicle in a touch-free manner after breaking the chemical bond; and
rinsing the detergent from the exterior surface of the vehicle in a touch-free manner.

20. The method of claim 12, further comprising forming the chemical bond by irradiating the exterior surface of the vehicle with electromagnetic radiation having a wavelength that corresponds to the energy required to form the chemical bond.

21. The method of claim 12, further comprising breaking a chemical bond within at least one of the plurality of PAHs.

22. A method of cleaning a vehicle, the method comprising:
irradiating an exterior surface of a vehicle with artificial electromagnetic radiation, the exterior surface of the vehicle having soil deposited thereon, at least a portion of the soil being bonded together via a chemical bond;
breaking the chemical bond with the artificial electromagnetic radiation having a wavelength in the UV spectrum;
applying detergent to the exterior surface of the vehicle in a touch-free manner after irradiating the exterior surface of the vehicle; and
rinsing the detergent from the exterior surface of the vehicle in a touch-free manner.

23. The method of claim 22, wherein the soil includes a plurality of PAHs.

24. The method of claim 22, wherein the chemical bond is formed between at least two of O, S, N and a metal ion.

25. The method of claim 24, wherein the metal ion includes an ion of at least one of Fe, Ni, V, Cu, Zn, Cd, Pb, Ti, Cr, Sr, and combinations thereof.

26. The method of claim 23, wherein the plurality of PAHs includes at least one of acenaphthene, acenaphthylene, acephenanthrylene, anthanthrene, anthracene, benzo[a]coronene, benzo[a]naphthacene, benzo[a]pyrene, benzo[b]chrysene, benzo[b]fluorene, benzo[c]chrysene, benzo[c]phenanthrene, benzo[e]pyrene, benzo[ghi]fluoranthene, benzo[ghi]naphtha[cde]perylene, benzo[ghi]perylene, benzo[j]fluoranthene, benzo[rst]dinaphtho[defg,ijkl]pentaphene, benzo[rst]phenanthro[1,10,9-cde], benz[a]anthracene, benz[e]acephenanthrylene, benz[rst]anthra[cde]pentaphene, chrysene, coronene, cyclopenteno[cd]pyrene, dibenzo[b,def]chrysene, dibenzo[bc,ef]coronene, dibenzo[cd,lm]perylene, dibenzo[g,p]chrysene, dibenzo[j,lm]naphtha[ab]perylene, dibenz[a,c]anthracene, dibenz[a,h]anthracene, dibenz[a,j]anthracene, dinaphtho[defg,opqr]pentacene, fluoranthene, fluorene, hexabenzo[a,cd,f,j,lm,o]perylene, naphthacene, naphthalene, naphtho[a]anthracene, naphtho[bcd]perylene, naphtho[d]coronene, pentabenzo[a,cd,f,j,lm]perylene, pentacene, pentaphene, perylene, phenanthrene, phenanthro[3,4-c]phenantrene, picene, pyranthrene, pyrene, tetrabenzo[a,cd,f,lm]perylene, triphenylene, and combinations thereof.

27. The method of claim 22, wherein the wavelength ranges from about 100 nm to about 400 nm.

28. The method of claim 22, wherein the wavelength ranges from about 230 nm to about 310 nm.

29. The method of claim 22, wherein breaking the chemical bond includes breaking the chemical bond without substantially pyrolyzing the soil.

30. The method of claim 22, further comprising forming the chemical bond by irradiating the exterior surface of the vehicle with electromagnetic radiation having a wavelength that corresponds to the energy required to form the chemical bond.

31. The method of claim 23, further comprising breaking a chemical bond within at least one of the plurality of PAHs.
